(19) United States
(12) Patent Application Publication
(10) Pub. No.: US 2013/0293543 A1
(43) Pub. Date: Nov. 7, 2013

(54) IMAGE PROCESSING APPARATUS AND METHOD

(71) Applicant: SAMSUNG ELECTRONICS CO., LTD., Suwon (KR)

(72) Inventors: Min Kyu JEONG, Yongin (KR); Jae Don Lee, Yongin (KR); Kwon Taek Kwon, Seoul (KR); Seung Won Lee, Hwaseong (KR); Shi Hwa Lee, Seoul (KR)

(73) Assignee: SAMSUNG ELECTRONICS CO., LTD., Suwon (KR)

(21) Appl. No.: 13/793,907

(22) Filed: Mar. 11, 2013

(30) Foreign Application Priority Data
May 7, 2012 (KR) 10-2012-0047839

(51) Int. Cl. G06T 15/00; G06T 15/80

(52) U.S. Cl. CPC G06T 15/005; G06T 15/80
USPC 345/423; 345/419

(57) ABSTRACT

An image processing apparatus. A rendering unit of the image processing apparatus may perform rendering with respect to each of N passes by applying a multi-pass rendering process with respect to an object in an image. The image processing apparatus may include a texture buffer to store information about at least one pixel using second pass rendering different from first pass rendering, while performing the first pass rendering corresponding to a process of generating a final result image among the N passes.

### CROSS-REFERENCE TO RELATED APPLICATIONS

This application claims the priority benefit of Korean Patent Application No. 10-2012-0047839, filed on May 7, 2012, in the Korean Intellectual Property Office, the disclosure of which is incorporated herein by reference.

### BACKGROUND

1. Field

Example embodiments of the following disclosure relate to an image processing apparatus and method, and more particularly, to an image processing apparatus and method that may perform high performance three-dimensional (3D) graphics and multimedia data processing.

2. Description of the Related Art

In real-time three-dimensional (3D) rendering, a rendering result of a single phase may be used as texture in a subsequent phase. Further, in a technique of 3D rendering, a signal object may be rendered multiple times using multiple passes. This method may be referred to as multi-pass rendering method.

The multi-pass rendering method may be used to express a reflection or a shadow with respect to a single object in an image.

In the multi-pass rendering method, generally, while initially rendering an image to be used as texture and then reusing the image for final image rendering, a rendering operation may be performed with respect to both a portion used for the final image rendering and a portion not used for the final image rendering.

For example, when performing rendering by dividing the final image rendering into two passes, only a portion of the rendering result obtained in a first pass may be used for final image rendering in a second pass.

Accordingly, a need exists for an improved image processing apparatus and method thereof.

### SUMMARY

According to an aspect of one or more embodiments, there is provided an image processing apparatus, including: a rendering unit to perform first rendering with respect to an object; and a texture buffer to store pixel information using a texture calculation in second rendering that is performed separate from the first rendering, based on the first rendering result. The rendering unit may perform the second rendering using the pixel information.

The rendering unit may generate a result image of the object by completing the first rendering using the second rendering result.

Each of the first rendering and the second rendering may correspond to a separate rendering pass that is performed using a multi-pass rendering process.

The second rendering may correspond to a process of generating the texture information that is used to perform the first rendering using the multi-pass rendering process.

The rendering unit may perform rendering with respect to at least one pass using a multi-pass rendering process.

The rendering unit may include: a tiling unit to divide a rendering area of a result image of the object into a plurality of tiles; a rasterization unit to calculate a pixel position corresponding to the object with respect to at least one of the plurality of tiles; a visibility test unit to perform a visibility test based on the pixel position; and a texturing and shading unit to perform texturing and shading based on the visibility test result.

The texturing and shading unit may determine at least one pixel using the second rendering during a first rendering process, and the texture buffer may store information about the at least one pixel.

The texture buffer may mask and store information about the at least one pixel.

The image processing apparatus may further include a frame buffer to store the first rendering result in a first frame buffer object, and to store the second rendering result in a second frame buffer object.

According to another aspect of one or more embodiments, there is provided an image processing apparatus, including: a rendering unit to perform rendering with respect to each of N passes by applying a multi-pass rendering process with respect to an object, wherein N denotes a natural number; a texture buffer to store information about at least one pixel using second pass rendering different from first pass rendering, while performing the first pass rendering corresponding to a process of generating a final result image among the N passes; and a frame buffer to store the rendering result about the final result image using the second pass rendering result and the first pass rendering result.

According to still another aspect of one or more embodiments, there is provided an image processing method, including: performing, by a rendering unit, first rendering with respect to an object; storing, by a texture buffer, pixel information using a texture calculation in second rendering that is performed separate from the first rendering, based on the first rendering result; and performing, by the rendering unit, the second rendering using the pixel information.

The image processing method may further include generating, by the rendering unit, a result image of the object by completing the first rendering using the second rendering result.

Each of the first rendering and the second rendering may correspond to a separate rendering pass that is performed using a multi-pass rendering process.

The second rendering may correspond to a process of generating the texture information that is used to perform the first rendering using the multi-pass rendering process.

The performing of the first rendering may include: dividing a rendering area of a result image of the object into a plurality of tiles; calculating a pixel position corresponding to the object with respect to at least one of the plurality of tiles; performing a visibility test based on the pixel position; and performing texturing and shading based on the visibility test result.

The performing of the texturing and shading may include: determining at least one pixel using the second rendering during a first rendering process; and storing, by the texture buffer, information about the at least one pixel.

According to another aspect of one or more embodiments, there is provided a method of image processing, including: performing an initial rendering to determine pixel information to be rendered in a different rendering; performing the different rendering using the determined pixel information; and completing the initial rendering using a result of the different rendering, and generating a final result image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus, according to an example embodiment;

FIG. 2 illustrates a configuration of a rendering unit of the image processing apparatus of FIG. 1, according to an example embodiment;

FIG. 3 illustrates a configuration of a frame buffer of the image processing apparatus of FIG. 1, according to an example embodiment;

FIG. 4 illustrates an example of a three-dimensional (3D) model object to describe an image processing method, according to an example embodiment;

FIG. 5 illustrates an example of a 3D model of FIG. 4 observed at a viewpoint corresponding to a result image, according to an example embodiment;

FIG. 6 illustrates an image processing method, according to an example embodiment;

FIG. 7 illustrates an image to describe a process of applying an image processing method to the 3D model of FIG. 4, according to an example embodiment;

FIG. 8 illustrates an image to describe a process of performing rendering of an (N−1)-th pass using the rendering result of an N-th pass in an image processing method, according to an example embodiment; and

FIG. 9 illustrates an image processing method, according to an example embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

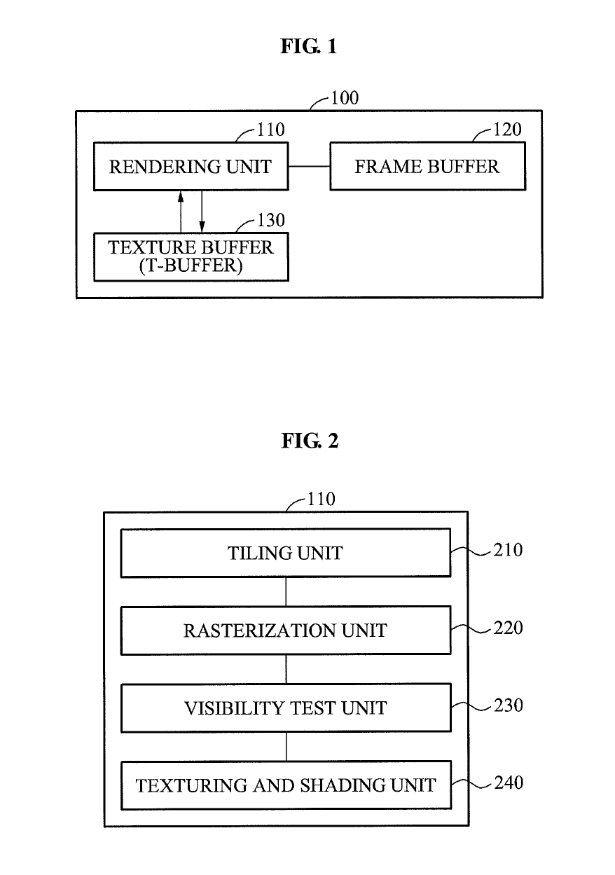

FIG. 1 illustrates an image processing apparatus 100, according to an example embodiment.

Referring to FIG. 1, the image processing apparatus 100 may include a rendering unit 110 and a texture buffer 130. In another example embodiment, the image processing apparatus 100 may additionally include a frame buffer 130. The rendering unit 110, the frame buffer 120, and the texture buffer 130 may each include at least one processing device.

The rendering unit 110 may perform rendering with respect to a three-dimensional (3D) model using a multi-pass rendering process.

A plurality of rendering passes may be included in the above rendering. The plurality of rendering passes may be sequentially performed. Alternatively, depending on embodiments, at least a portion of the plurality of rendering passes may be performed in parallel.

The rendering unit 110 of the image processing apparatus 100 may perform other rendering passes (hereinafter, referred to as second rendering) prior to performing a rendering pass (hereinafter, referred to as first rendering) corresponding to a process of generating a final result image, among the plurality of rendering passes.

In general multi-pass rendering, since texture information corresponding to the second rendering result, and the like, is partially used for first rendering corresponding to a process of generating a final result image, the second rendering may be initially performed. According to an example embodiment, the first rendering may be initially performed prior to the second rendering.

Depending on example embodiments, pixels having texture information to be rendered in the second rendering may be determined from the initially performed first rendering result. Pixel position information based on the determination, and the like, may be stored in the texture buffer 130.

The rendering unit 110 may perform the second rendering using the pixel information, stored in the texture buffer 130.

The rendering unit 110 may complete the first rendering using the second rendering result, for example, the texturing and shading result, after initially performing the first rendering.

During a first rendering process, the rendering result obtained may be stored, for example, in the texture buffer 130. Based on the second rendering result, the frame buffer 120 may be updated. Through this, a result image may be generated.

FIG. 2 illustrates a configuration of the rendering unit 110 of the image processing apparatus 100 of FIG. 1, according to an example embodiment.

During a process of performing multi-pass rendering according to example embodiments of the present disclosure, the rendering unit 110 of the image processing apparatus 100 may include a tiling unit 210 to divide, into a plurality of tiles, an image observed from a viewpoint at which an object is to be rendered, that is, a camera viewpoint.

With respect to each of the plurality of times that is obtained as the tiling result, a rasterization unit 220 may calculate a pixel position of a pixel to be rendered in correspondence to the object in the image.

A visibility test unit 230 may determine whether shading of a pixel value is required through a visibility test based on the calculated pixel position.

A texturing and shading unit 240 may calculate color values by performing texturing and shading to calculate a color value of each pixel.

According to an example embodiment, during a first rendering process, the texturing and shading unit 240 may determine pixel positions of pixels having texture information to be calculated through second rendering.

The calculated pixel positions may be masked to the texture buffer 130 of FIG. 1 and be used during the second rendering process.

According to an example embodiment, the rendering unit 110 may include a plurality of units that include the tiling unit 210 through the texturing and shading unit 240. In this case, individual units may sequentially perform a plurality of rendering passes that is included in a multi-pass rendering process, or may perform at least a portion of the plurality of rendering passes in parallel.

The above detailed configuration included in the rendering unit 110 is only an example and thus, at least a portion thereof may be omitted based on a rendering process, or at least two units may be configured into a single physical unit, and as such, the present disclosure is not limited thereto.

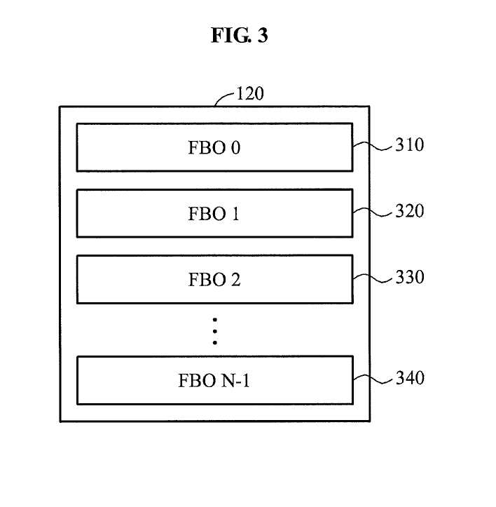

During the multi-pass rendering process, the rendering result of each individual pass may be stored in the frame buffer 120. FIG. 3 illustrates a configuration of the frame buffer 120 of the image processing apparatus 100 of FIG. 1, according to an embodiment.

According to an example embodiment, a plurality of frame buffer objects (FBOs) corresponding to the respective rendering passes may be included in the frame buffer 120.

For example, when N rendering passes are included in the multi-pass rendering process, the result of N rendering passes may be stored in FBO (0) 310, FBO (1) 320, FBO (2) 330, . . . , FBO (N−1) 340, respectively.

As described above, according to an example embodiment, the image processing apparatus 100 may perform rendering with respect to N passes by applying a multi-pass rendering process with respect to an object to be rendered. Here, N denotes a natural number. Among the N passes, the image processing apparatus 100 may initially perform first pass rendering corresponding to a process of generating a final result image prior to performing other rendering passes.

During the above process, pixel information to be rendered in other passes may be stored in the texture buffer 130. The first pass rendering result may be stored in, for example, the FBO (0) 310. When the rendering result about other passes is obtained, a process of updating the FBO (0) 310 using the obtained rendering results of other FBOs may be performed.

Hereinafter, an operation of the image processing apparatus 100 will be further described with reference to an exemplary 3D model object.

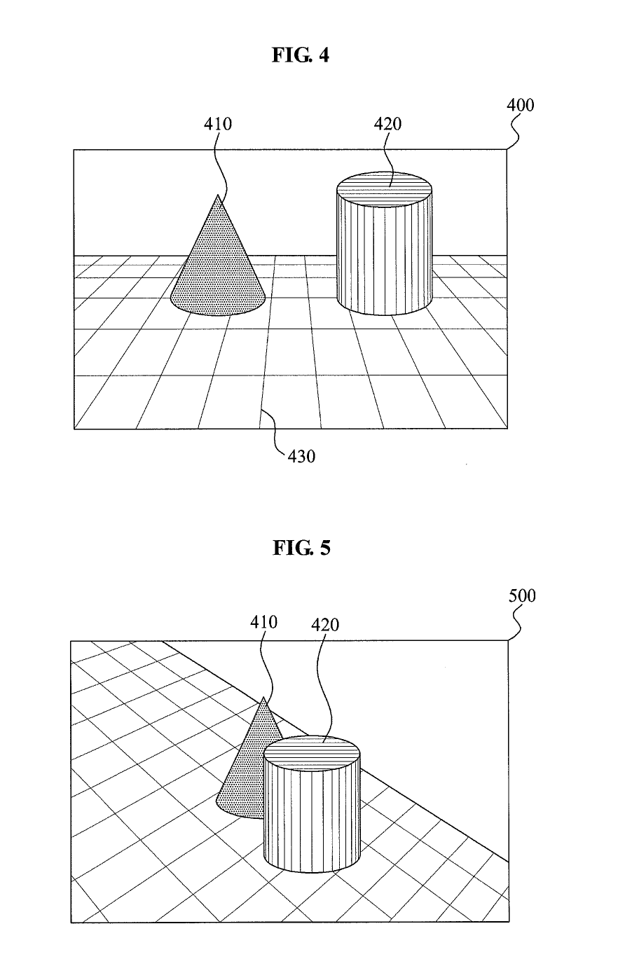

FIG. 4 illustrates an image 400 including a 3D model object to describe an image processing method, according to an example embodiment.

Referring to FIG. 4, an object 410 and an object 420 of a 3D model are disposed on a ground 430. A result image of the 3D model observed at a predetermined viewpoint, e.g., the viewpoint shown in FIG. 4, may be rendered.

The above rendering may be performed using a multi-pass rendering process. As described above, multi-pass rendering may be understood as a process of rendering a 3D model using a plurality of rendering passes.

Each pass may correspond to the aforementioned rendering process, such as a rasterization process, a visibility test process, a texturing and shading process, and the like, each of which are performed with respect to at least a portion of objects of the 3D model.

For example, in N passes, rendering may be dividedly performed with respect to at least a portion of objects in the 3D model. Texture information that is the rendering result of an (N−1)-th pass may be used for rendering of an N-th pass. In the multi-pass rendering process, texture information that is the rendering result of an (N−2)-th pass may be used for rendering result of the (N−1)-th pass.

The rendering of the N-th pass may be a process of regenerating the final result image observed at the predetermined viewpoint. However, it is only an example and thus, rendering of the N-th pass may correspond to rendering of a predetermined pass during the multi-pass rendering process of generating the result image of the 3D model that is observed at the predetermined viewpoint. Therefore, even though embodiments in which rendering of the N-th pass is a process of generating the final result image are described throughout the present specification, rendering of the N-th pass should be understood to include predetermined pass rendering of the multi-pass rendering.

According to an example embodiment, in the multi-pass rendering process, texture information that is the rendering result of a previous pass of the N-th pass, for example, an (N−1)-th pass is used for a rendering process of a subsequent pass, for example, the N-th pass. Further, only a portion of texture information that is the rendering result of the (N−1)-th pass may be used for the rendering result of the N-th pass, thereby reducing the amount of processing of the rendering operation.

When texturing and shading is performed with respect to a portion that is not used for the rendering result of the N-th pass in the (N−1)-th pass rendering, for example, due to an occlusion, thus, processing and overhead of operation resources may increase.

Accordingly, the image processing apparatus 100 may initially perform rendering of the N-th pass, for example, a pass corresponding to the final result image, and may obtain pixel information to be textured and shaded in the (N−1)-th pass, the (N−2)-th pass, and the like, in advance.

The obtained pixel information may be stored in the texture buffer 130 of the image processing apparatus 100. When the rendering unit 110 performs rendering of the (N−1)-th pass, the (N−2)-th pass, and the like, texturing and shading may be performed only with respect to portions corresponding to the pixel information that is stored in the texture buffer 130.

The result of texturing and shading performed with respect to the respective passes may be stored in the FBO (0) 310, FBO (1) 320, FBO (2) 330, . . . , FBO (N−1) 340 of FIG. 3, respectively, thereby enabling the final result image to be efficiently rendered in the N-th pass.

Accordingly, it is possible to significantly decrease overhead of operations that are unnecessarily performed between a plurality of passes in the multi-pass rendering process.

The above embodiments will be further described with reference to FIG. 5 through FIG. 8.

FIG. 5 illustrates an image 500 of the 3D model of FIG. 4 observed at a viewpoint corresponding to a result image, according to an example embodiment;

When observing the 3D model of FIG. 4 from a viewpoint at which the result image is to be rendered, for example, a predetermined viewpoint also called a camera viewpoint, a portion of the object 410 may be occluded by the object 420.

Accordingly, in the case of multi-pass rendering in which rendering is performed by classifying passes for each object, the whole rendering does not need to be performed with respect to the entire object 410 since texturing and shading information is not used in the final result image with respect to the occluded portion of the object 410.

As such, according to an example embodiment of the present disclosure, the rendering unit 110 of the image processing apparatus 100 may initially perform N-th pass rendering in which the final result image corresponding to the image 500 is rendered, prior to performing rendering of the (N−1)-th pass, the (N−2)-th pass, and the like.

Pixel information used for the final result image may be induced and the pixel information may be stored in the texture buffer 130.

With respect to the individual passes such as the (N−1)-th pass, the (N−2)-th pass, and so on, rendering may be efficiently performed based on information corresponding to a corresponding pass in the pixel information that is stored in the texture buffer 130.

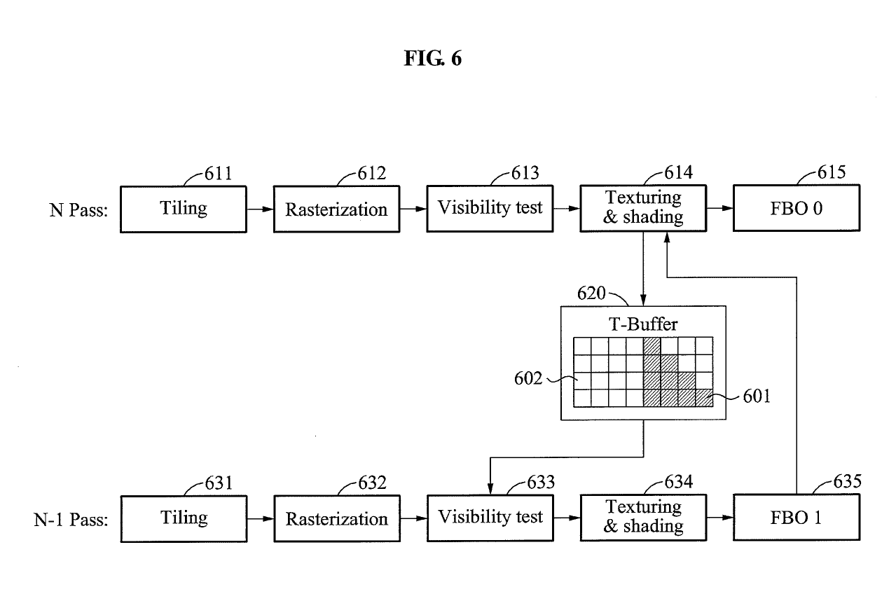

The above process will be further described with reference to FIG. 6.

FIG. 6 illustrates an image processing method, according to an example embodiment.

In a multi-pass rendering process, in the art, an (N−1)-th pass including operations 631 through 635 may be initially performed. The rendering result of the (N−1)-th pass stored in an FBO 1 may be used for texturing and shading in operation 614, and the rendering result of the final result image may be stored in an FBO 0.

According to an example embodiment, as shown in FIG. 6, the N-th pass associated with rendering of the final result image may be initially performed prior to the (N−1)-th pass and the like. For example, rendering of the final result image in the multi-pass rendering process may be initially performed to determine information relating to the portion used for the rendering result of the N-path corresponding to the final result image.

In operation 611, image tiling may be performed based on the objects 410 and 420 and a background associated with the N-th pass. The above tiling process is a process of performing rendering for each tile and thus, may be optionally configured.

In operation 612, rasterization may be performed for each tile to calculate pixel position information of a corresponding tile and the like.

During the above process, a visibility test may be performed in operation 613 and pixels desired to be textured and shaded in the final result image may be determined.

While performing texturing and shading with respect to the determined pixels in operation 614, a portion of the pixels may need to use texture information of another pass excluding the N-th pass, for example, texture information of the (N−1)-th pass.

In operation 614, with respect to pixels that need to use texture information of another pass, such as, the (N−1)-that pass and the like, a process up to calculate a position of a corresponding pixel may be performed. A position and data required to perform a remaining operation may be stored in the texture buffer 130 of FIG. 1. Here, when predetermined information is previously stored in the texture buffer 130, the above storage process may be understood as a process of updating an existing texture buffer.

For example, pixels 601 may correspond to a portion in which the texturing and shading result of another pass is used. Pixels 602 may correspond to a portion in which a final color value is calculated using only the N-th pass.

Information about the above portions may be managed in a mask form.

As described above, a texture buffer 620 (shown as T-Buffer in FIG. 6) may store data required for color calculation, for example, shading, and positions of pixels using texturing and shading in another pass excluding the N-th pass, for example, the (N−1)-th pass, and the like.

In this case, the texture buffer 620 may store portions to be textured and shaded in another pass, for example, the (N−1)-th pass and the like, together with pass information.

In the N-th pass, only with respect to pixels that do not use the rendering result of another pass, a process up to a color value calculation may be completed and the calculated color value may be stored in the FBO 0 in operation 615.

Through the above process, a portion of the result image may be completed and another portion of the result image may be completed after performing rendering of other passes associated with multi-pass rendering, for example, rendering of the N-th pass.

Next, rendering of the (N−1)-th pass may be performed. In a visibility test process of operation 633 performed after the tiling and rasterization is performed in operations 631 and 632, a visibility test may be performed only with respect to a portion of the entire pixels based on information that is stored in the texture buffer 620.

Here, the rendering unit 110 may perform the visibility test in operation 633 by selecting only a tile included in a masked pixel, as a tile that uses rendering of the (N−1)-th pass.

In this example, by comparing the entire tile pixels and a pixel masked in the texture buffer 620, texturing and shading of the (N−1)-th pass may be performed with respect to pixels to be used for the result image in operation 634.

For example, pixels that pass the visibility test in operation 633 may be pixels that use texture information to complete N-th pass rendering corresponding to a process of generating the final result image.

In operation 635, the result of texturing and shading performed with respect to the above pixels in operation 634 may be stored in the FBO 1.

Information stored in the FBO 1 may be reflected in texturing and shading of the N-pass in operation 614 and the FBO 0 may be updated again. Accordingly, rendering of the final result image may be completed.

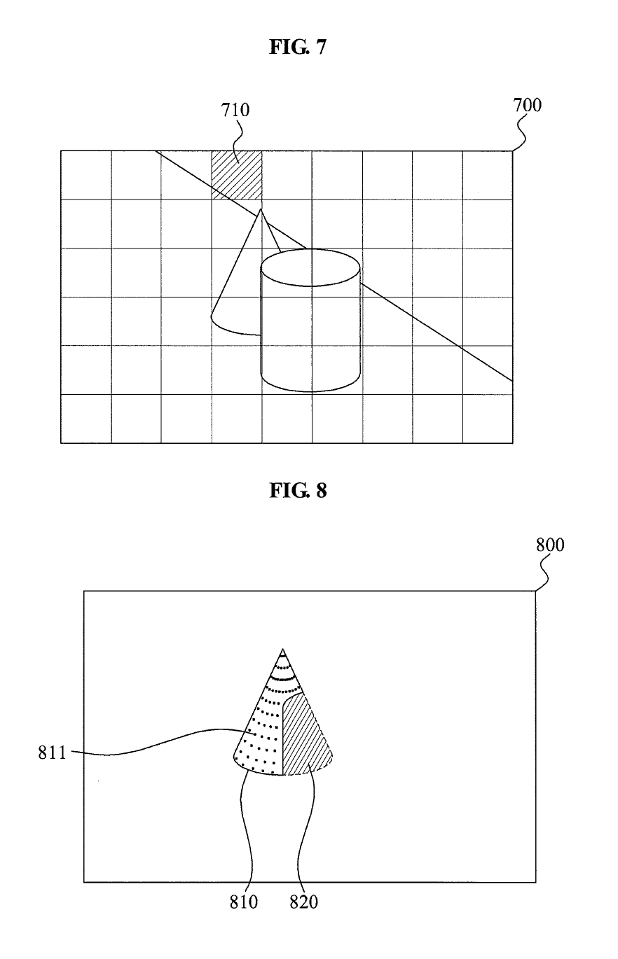

The above tiling process and texture buffer updating process will be further described with reference to FIG. 7 and FIG. 8.

FIG. 7 illustrates an image 700 to describe a process of applying the image processing method to the 3D model of FIG. 4, according to an example embodiment.

While performing rendering with respect to an N-th pass, the image processing apparatus 100 may perform rasterization and a visibility test with respect to each of the tiles obtained through tiling, for example, a tile 710. Positions of pixels requiring texturing and shading may be calculated for each tile.

During the above process, pixels that require the result of texturing and shading performed in a previous pass excluding the N-th pass, for example, an (N−1)-th pass, may be masked in the texture buffer 620 of FIG. 6.

Further, rendering of the (N−1)-th pass may be performed. In the (N−1)-th pass, the visibility test of operation 633 and the texturing and shading process of operation 634 may be performed only with respect to a portion that requires the (N−1)-th pass rendering, based on masking information of the texture buffer 610, instead of being performed with respect to the entire tiles. Accordingly, a calculation amount may significantly decrease.

FIG. 8 illustrates an image 800 to describe a process of performing rendering of the (N−1)-th pass using the rendering result of the N-th pass in the image processing method, according to an example embodiment.

For example, when the object 410 of FIG. 4 is assumed to be rendered in the (N−1)-th pass, rendering of the (N−1)-th pass may be performed with respect to a portion 810 that is used for the final image and a portion 820 that is occluded by the object 420 and thus, is not used for the final image, in the (N−1)-th pass rendering according to the general multi-pass rendering process.

In the image processing method according to an example embodiment, the visibility test of operation 633 and the texturing and shading process of operation 634 may be omitted with respect to the portion 820 that is not used for the final image.

Accordingly, the result of the visibility test and the texturing and shading process that are performed only with respect to pixels 811 that need to be used for the final image in operations 633 and 634 may be stored in the FBO 1. The above result may be used for the N-th pass rendering and be used to render the final image.

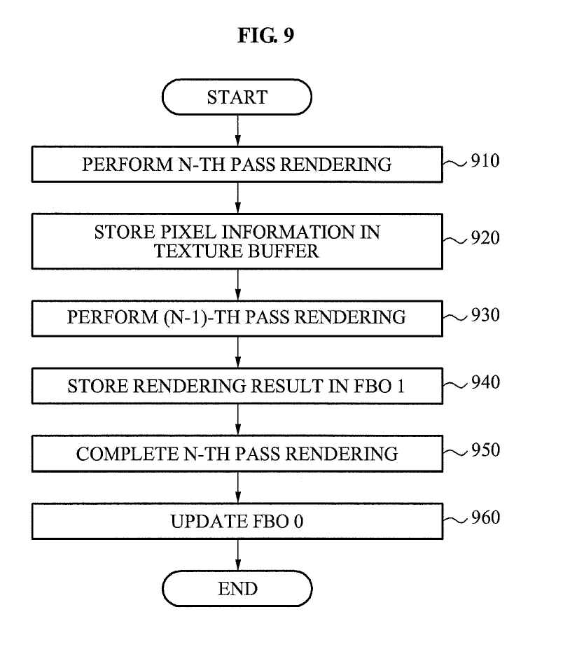

FIG. 9 illustrates an image processing method, according to an example embodiment.

According to an example embodiment, a multi-pass rendering process of performing rendering with respect to each of N passes may be performed. Here, N denotes a natural number.

In operation 910, the rendering unit 110 of FIG. 1 may initially perform N-th pass rendering, for example, first rendering corresponding to a process of generating a final result image of an object in an image.

In operation 920, pixel information using a texture calculation in second rendering may be determined based on the first rendering result that was initially performed. The determined pixel information may be stored in the texture buffer 130, for example. Here, the second rendering may be performed separate from the first rendering.

In operation 930, the rendering unit 110 may perform (N−1)-th pass rendering, for example, the second rendering with respect to the object based on the pixel information.

In operation 940, the (N−1)-th pass rendering result may be stored in an FBO 1. In operation 950, the N-th pass rendering may be completed based on information that is stored in the FBO 1.

In operation 960, the final FBO 0 may be updated using a pixel value pre-calculated in operation 910 and additionally using a pixel value according to the rendering process of operation 950. Accordingly, the final result image may be generated.

The image processing method according to the above-described embodiments may be recorded in non-transitory computer-readable media including program instructions to implement various operations embodied by a computer. The media may also include, alone or in combination with the program instructions, data files, data structures, and the like. The results produced can be displayed on a display of the computing hardware. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW.

Further, according to an aspect of the embodiments, any combinations of the described features, functions and/or operations can be provided.

Moreover, the image processing apparatus may include at least one processor to execute at least one of the above-described units and methods.

Although embodiments have been shown and described, it would be appreciated by those skilled in the art that changes may be made in these embodiments without departing from the principles and spirit of the disclosure, the scope of which is defined by the claims and their equivalents.

1. An image processing apparatus, comprising:
a rendering unit to perform first rendering with respect to an object; and
a texture buffer to store pixel information using a texture calculation in second rendering, based on a result of the first rendering,
wherein the rendering unit performs the second rendering using the pixel information.

2. The image processing apparatus of claim 1, wherein the second rendering is performed separate from the first rendering.

3. The image processing apparatus of claim 1, wherein the rendering unit generates a result image of the object by completing the first rendering using a result of the second rendering.

4. The image processing apparatus of claim 1, wherein each of the first rendering and the second rendering corresponds to a separate rendering pass that is performed using a multi-pass rendering process.

5. The image processing apparatus of claim 4, wherein the second rendering corresponds to a process of generating the texture information that is used to perform the first rendering using the multi-pass rendering process.

6. The image processing apparatus of claim 1, wherein the rendering unit performs rendering with respect to at least one pass using a multi-pass rendering process.

7. The image processing apparatus of claim 6, wherein the rendering unit comprises:
a tiling unit to divide a rendering area of a result image of the object into a plurality of tiles;
a rasterization unit to calculate a pixel position corresponding to the object with respect to at least one of the plurality of tiles;
a visibility test unit to perform a visibility test based on the pixel position; and
a texturing and shading unit to perform texturing and shading based on the visibility test result.

8. The image processing apparatus of claim 7, wherein:
the texturing and shading unit determines at least one pixel using the second rendering during a first rendering process, and
the texture buffer stores information about the at least one pixel.

9. The image processing apparatus of claim 8, wherein the texture buffer masks and stores information about the at least one pixel.

10. The image processing apparatus of claim 1, further comprising:
a frame buffer to store the result of the first rendering in a first frame buffer object, and to store a result of the second rendering in a second frame buffer object.

11. An image processing apparatus, comprising:
a rendering unit to perform rendering with respect to each of N passes by applying a multi-pass rendering process with respect to an object, wherein N denotes a natural number;
a texture buffer to store information about at least one pixel using second pass rendering different from first pass rendering, while performing the first pass rendering corresponding to a process of generating a final result image among the N passes; and
a frame buffer to store a result of the rendering about the final result image using a result of the second pass rendering and a result of the first pass rendering.

12. An image processing method, comprising:
performing, by a rendering unit, first rendering with respect to an object;
storing, by a texture buffer, pixel information using a texture calculation in second rendering, based on a result of the first rendering; and
performing, by the rendering unit, the second rendering using the stored pixel information.

13. The image processing method of claim 12, wherein the second rendering is performed separate from the first rendering.

14. The method of claim 12, further comprising:
generating, by the rendering unit, a result image of the object by completing the first rendering using the second rendering result.

15. The method of claim 12, wherein each of the first rendering and the second rendering corresponds to a separate rendering pass that is performed using a multi-pass rendering process.

16. The method of claim 15, wherein the second rendering corresponds to a process of generating the texture information that is used to perform the first rendering using the multi-pass rendering process.

17. The method of claim 12, wherein the performing of the first rendering comprises:
dividing a rendering area of a result image of the object into a plurality of tiles;
calculating a pixel position corresponding to the object with respect to at least one of the plurality of tiles;
performing a visibility test based on the pixel position; and
performing texturing and shading based on the visibility test result.

18. The method of claim 17, wherein the performing of the texturing and shading comprises:
determining at least one pixel using the second rendering during a first rendering process; and
storing, by the texture buffer, information about the at least one pixel.

19. A non-transitory computer-readable medium comprising a program for instructing a computer to perform an image processing method, comprising:
performing first rendering with respect to an object;
storing pixel information using a texture calculation in second rendering, based on a result of the first rendering; and
performing the second rendering using the pixel information.

20. The non-transitory computer-readable medium of claim 19, wherein the second rendering is performed separate from the first rendering.

21. A method of image processing, comprising:
performing an initial rendering to determine pixel information to be rendered in a different rendering;
performing the different rendering using the determined pixel information; and
completing the initial rendering using a result of the different rendering, and generating a final result image.
